(19) United States
(12) Patent Application Publication
(10) Pub. No.: US 2008/0272107 A1
(43) Pub. Date: Nov. 6, 2008

(54) Table Heater Heat Distribution Cone

(75) Inventors: Ken Maitland, Bowling Green, KY (US); Jerry McColgin, Westfield, IN (US); Maureen Carroll, Atlanta, GA (US); Michael E. Docherty, Boca Raton, FL (US); Pete Moyer, Bowling Green, KY (US); Chungkin Yee, Bowling Green, KY (US); Griffin Bland, Bowling Green, KY (US)

Correspondence Address: MIDDLETON & REUTLINGER, 2500 BROWN & WILLIAMSON TOWER, LOUISVILLE, KY, 40202, US

(73) Assignee: DESA IP, LLC, Miami, FL (US)

(21) Appl. No.: 11/684,863

(22) Filed: Mar. 12, 2007

(51) Int. Cl. H05B 1/00

(52) U.S. Cl. 219/218

(57) ABSTRACT

In one embodiment the instant invention combines a table and a heater in one product having a deflector cone under the table top. This embodiment resembles a small table with a table top surface and combines the usable table top surface with a heating element, which may use propane as a fuel source. There may be one or more deflector cones stacked on each other, and they may be made from heat-reflecting material.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Invention

The present invention relates to a combination table and heater. More particularly, the invention relates to a pillar heater having deflector cones below a table top where the deflector cones force heat away from the table top so that the table heater can be used for outdoor dining and recreation.

### BRIEF DESCRIPTION OF THE DRAWINGS

The aspects and advantages of the present invention will be better understood when the detailed description of the preferred embodiment is taken in conjunction with the accompanying drawings, in which:

FIG. 1 is a plan view of one embodiment of the invention;

FIG. 2 is an exploded view of an embodiment of the invention;

FIG. 3 is an exploded view of the base and support pillars of the invention;

FIG. 4 is a perspective view of a cabinet assembly of the invention;

FIG. 5 is an exploded view of an embodiment of the heating area or combustion chamber of the invention;

FIG. 6 is an exploded view of a grate and emitter assembly of the invention;

FIG. 7 is an exploded view of the emitter assembly of the invention;

FIG. 8 is a perspective view of an embodiment of the grate of the invention;

FIG. 9 is an exploded view of the deflector pans of one embodiment of the invention;

FIG. 10 is an exploded view of an embodiment of the table top of the invention;

FIG. 11 is a perspective view of one embodiment of the invention;

FIG. 12 is cut away view of an embodiment of the invention having deflector cones; and

FIG. 13 is a cut-away view of an embodiment of the invention having frusto-conical deflectors.

### DETAILED DESCRIPTION OF THE DRAWINGS

While this invention is capable of embodiments in many different forms, multiple embodiments are shown in the figures and will be herein described in detail. The present disclosure is to be considered an exemplification of the principles of the invention and is not intended to limit the broad aspects of the invention to the embodiments illustrated.

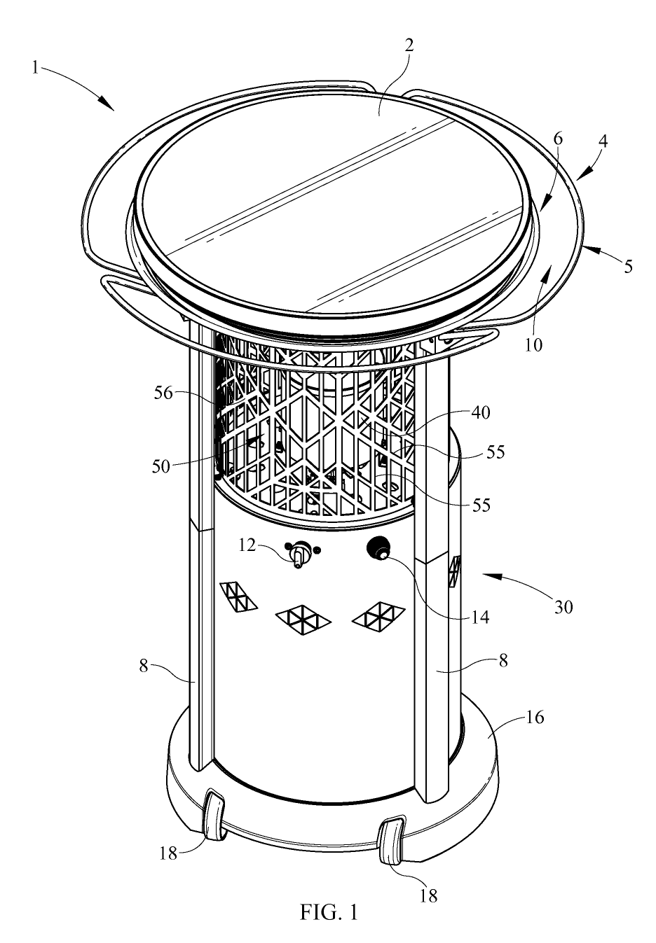

Referring now to FIG. 1, in one embodiment the bistro table heater 1 of the invention comprises a table 2 having a heating area or combustion chamber 50 below it. The heating area or combustion chamber 50 comprises a heat source positioned below the table top. In FIG. 1, the heat source is a radiant emitter assembly 40 positioned below the table 2. Heat emanates from the heating area or combustion chamber 50 in a 360 degree pattern around the bistro table heater 1 due to the burner 60 and the grate 56 of the heating area or combustion chamber 50. The heating area or combustion chamber 50 is covered by a grate 56 having a plurality of apertures 55. The apertures 55 of the grate 56 allow heat out of the heating area or combustion chamber 50, but the grate 56 partially shields the burner 60 of the heating area or combustion chamber 50 from weather or other physical interference. While apertures 55 are shown in one embodiment, the wall of the heating area or combustion chamber 50 may also be constructed with slots, openings or simple continuous heat radiating surfaces, all designed to allow heat to radiate outward from the chamber 50.

In the embodiment shown in FIG. 1, the table 2 is surrounded by a heat guard rail 4, which in FIG. 1 is attached to support pillars 8 at several places. The heat guard rail may, however, be attached to the table 2 at various places. The heat guard rail 4 allows people sitting or standing near the table heater 1 to lean against the rail 4 for support. In addition, although the table 2 is wider than the heating area or combustion chamber 50 and thus acts as a buffer from the heat, the heat guard rail 4 also causes people to maintain their distance from the heating area or combustion chamber 50. Given its relatively close proximity to the heating area or combustion chamber 50, the table 2 may become somewhat warm after extended use, but due to the design of the table heater 1, the temperature of the table 2 should not become elevated enough to cause pain or discomfort to anyone who leans against it, even if they do so for an extended period of time. In addition, the heat guard rail 4 has an outside edge 5 that defines an extended area 10 between the heat guard rail 4 and the table 2. In the embodiment shown in FIG. 1, the extended area 10 is an empty space, although it may comprise other configurations and connections to the heater 1.

Below heating area or combustion chamber 50 is cabinet assembly 30. Generally, cabinet assembly 30 has enough space to store the energy source for the heat source so that the table heater 1 functions as a self-contained unit, and can be easily moved as desired. The energy source, a propane tank in one embodiment, should fit within the cabinet assembly 30 and rest on base 16. In the embodiment shown in FIG. 1, base 16 has wheels 18 that ensure the mobility of table heater 1.

The embodiment shown in FIG. 1 further comprises a control knob 12 and ignitor 14 located on the outside of the cabinet assembly 30. Several support pillars 8 vertically extend along the length of the table heater 1 at several places on the heater. The support pillars 8 connect to other parts of the table heater 1 in order to maintain the physical integrity of the entire structure.

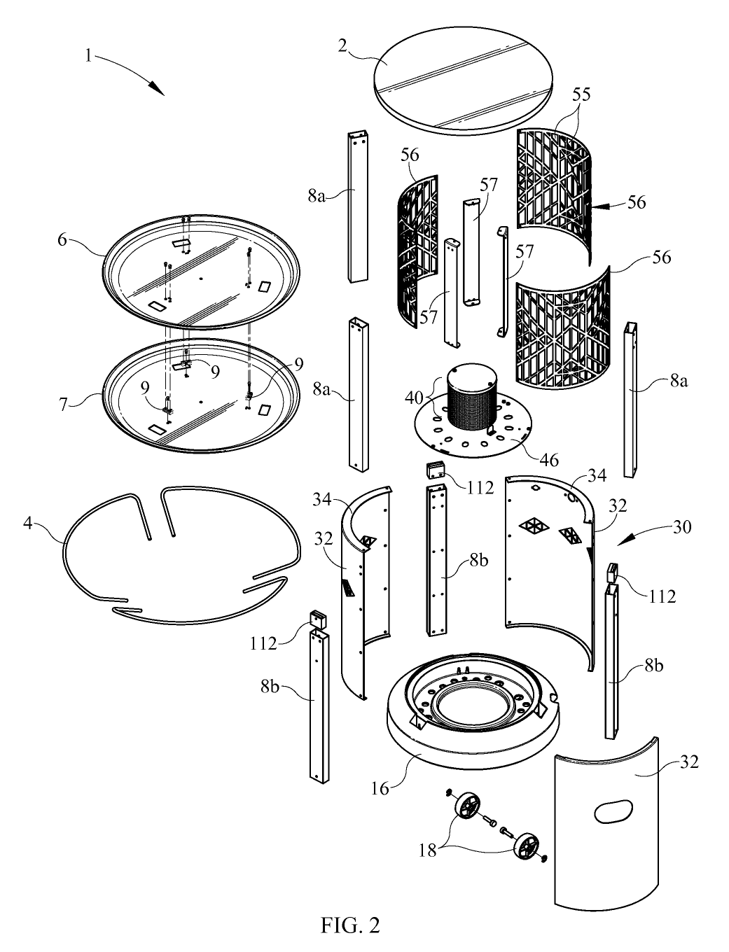

In one embodiment, the bistro table heater 1 comprises one or more support pillars 8 that add stability and rigidity to the design of the table. In the embodiment shown in FIG. 2, the support pillars 8 can vertically traverse the length of the table heater 1 up to the deflectors 6, 7 at different points on each perimeter. The support pillars 8 are spaced at intervals around the heater 1 to ensure that the whole of the heating area or combustion chamber 50 and the cabinet assembly 30 are adequately supported. A base 16 sits at the bottom of the table heater 1.

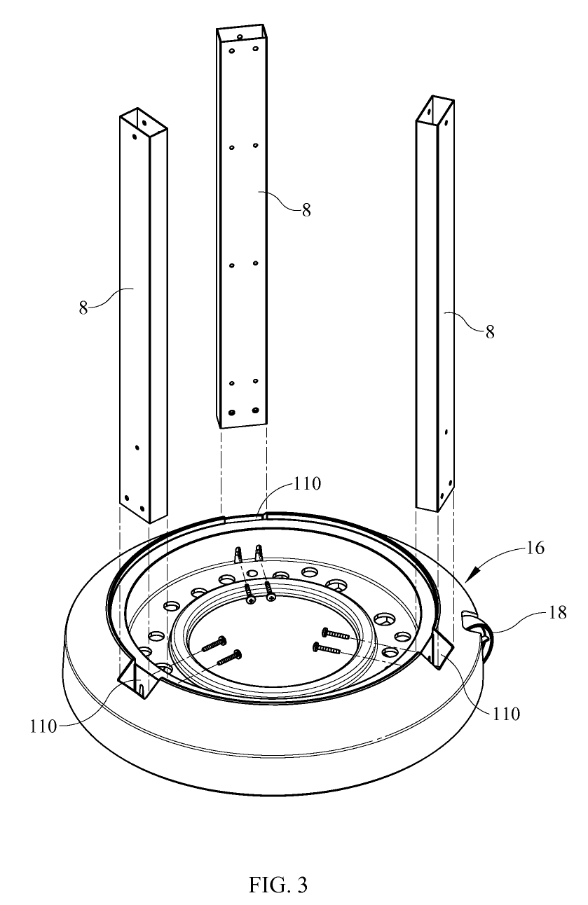

FIG. 3 shows how the support pillars 8 attach to the base 16, and wheels 18 are also visible. In the embodiment shown in FIG. 2, the pillars 8 are hollow and are made of a strong metal material. The bottom of the individual pillars 8 insert into notches 110 in base 16 and are then attached to the base 16 by screws.

Turning now to FIG. 2, the invention may have one or more deflectors 6, 7 below the table 2. The deflectors 6, 7 redirect heat away from the table 2 so that the table 2 remains cool even when the table heater 1 emits a large amount of heat. Below the table 2 is a heat source, which in FIG. 2 is an emitter assembly 40. In another embodiment of the invention, the heat source may comprise a ring burner. The emitter assembly 40 is located a sufficient distance away from the deflectors 6, 7 so that a great deal of heat radiates out through one or more apertures 55 in grate 56.

Located further below the heating area or combustion chamber 50 is a cabinet assembly 30. In the embodiment shown in FIG. 2, the cabinet assembly comprises a door panel 32 and one or more control panels 34. The door panel 32 can be used to open the cabinet assembly 30 so that a propane tank or other energy source can be stored within the heater table 1. The energy source of the heater is self-contained, thereby making the heater table 1 easily portable. In one embodiment of the invention, the base 16 has wheels 18 which allow for mobility. The wheels 18 could be for example swivel-type wheels, ball type wheels or fixed-position wheels to allow rolling of the unit over the ground.

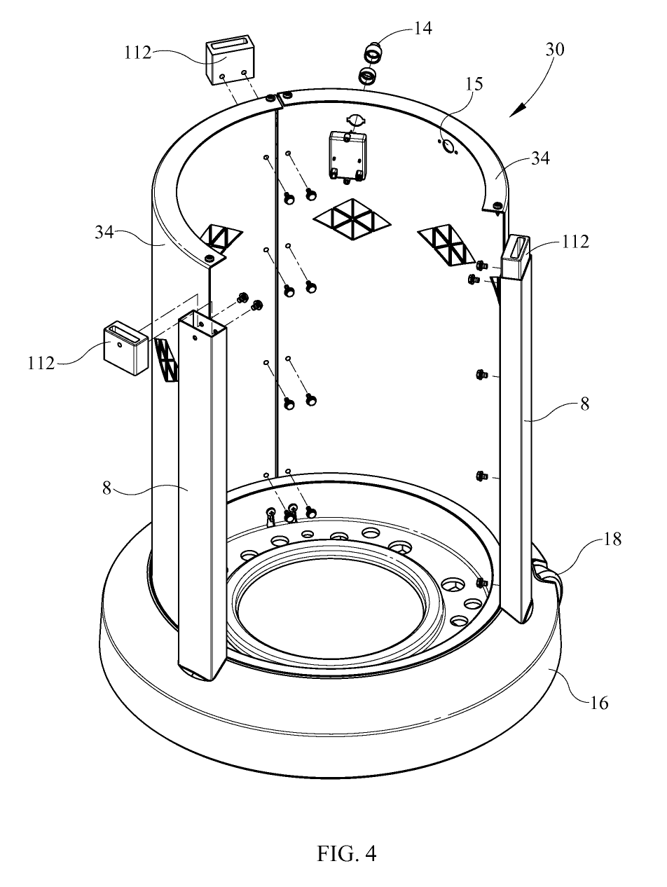

As shown in FIGS. 3 and 4, wheels 18 are rotatably attached to base 16. Base 16 may be hollow and provides space for a propane tank or other energy source. The cabinet assembly 30 generally comprises door panel 32, and control panels 34. Door panel 32 can be opened in order to remove the propane tank after it is empty. Ignitor 14 is also shown in FIG. 4, as is a hole 15 for the control knob 12. Brackets 112 can be attached to support pillars 8 in order to secure control panels 32 in place on top of base 16. As shown in FIG. 4, screws or other fasteners can be used for this purpose.

As is also shown in FIG. 4, base 16 sits at the very bottom of table heater 1 for support. Other types of support structures can also be used with the table heater 1 of the embodiment. The base 16 and cabinet assembly 30 ensures a consistent and stable support for the heat source so that heat consistently emanates from the table heater 1.

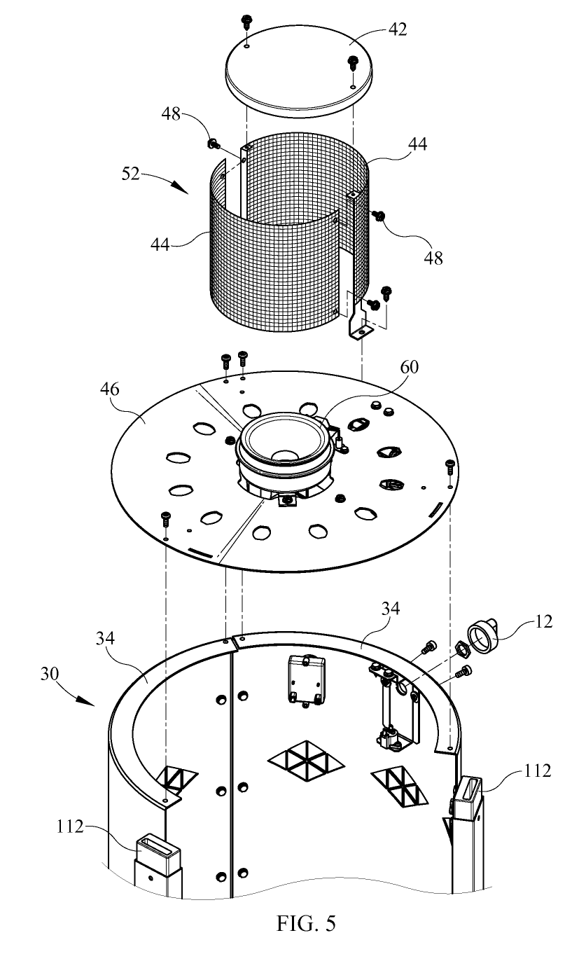

In the embodiment of the invention shown in FIGS. 1 and 5, the heat source of heating area or combustion chamber 50 comprises an emitter assembly 40. The emitter assembly 40 comprises one or more burner screens 44 that can be joined together by screws 48 or other fasteners and covered by an emitter cap 42. The burner screen 44 shown in FIG. 5 is cylindrical, but the burner screen 44 may also be cubical or any other shape that encloses enough space for a burner 60. The burner screen 44 of FIG. 5 comprises wire mesh and has many small openings, which allows heat from the burner 60 to escape.

Below the emitter assembly 40 is a burner support plate 46 to which the burner 60 may be attached. It can be seen that when the burner screen 44 is attached to the burner support plate 46, its radius is approximately half the radius of the burner support plate 46. Having a heat source that is too large could cause excessive heat to be generated from the heating area or combustion chamber 50. As is also visible in FIG. 5, screws or other fasteners attach burner support plate 46 to cabinet assembly 30. Control knob 12 can also be attached to one of the control panels 32.

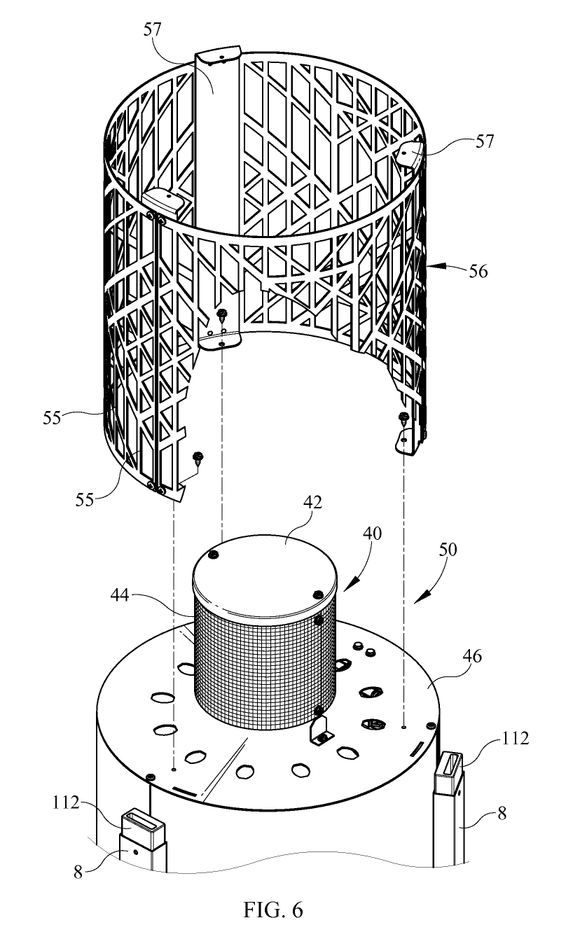

Turning now to FIGS. 1 and 6, once the emitter assembly 40 is attached to the burner support plate 46, grate 56 can be attached to the burner support plate 46 around emitter assembly 46 so that the grate 56 encloses heating area or combustion chamber 50. The grate 56 acts to partially shield the combustion chamber 50 from weather interference with the operation of the heat source, and can limit inadvertent user contact with the heating area or combustion chamber 50.

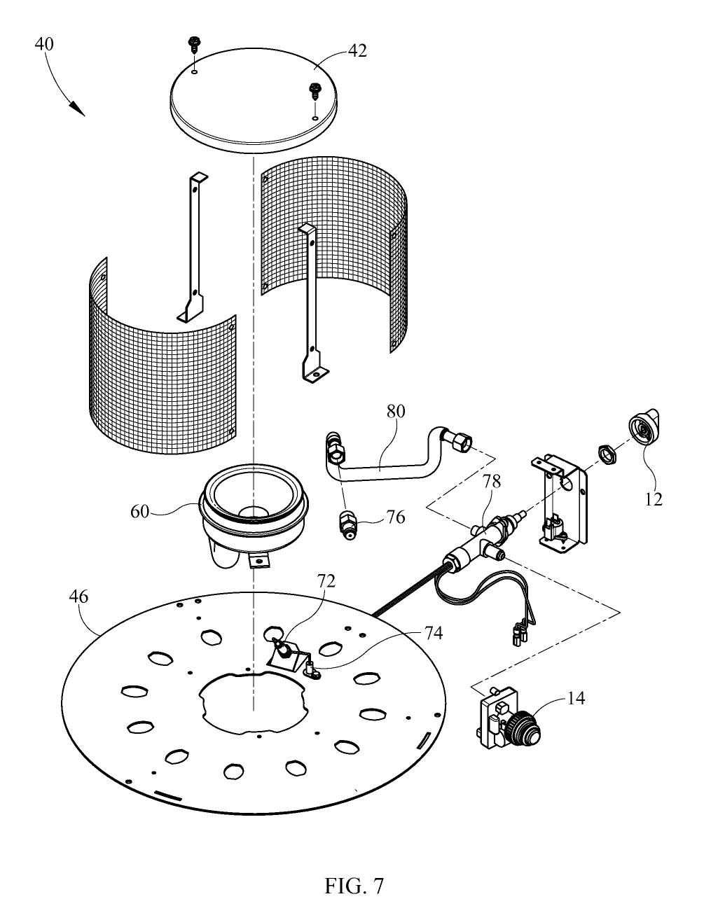

Turning now to FIG. 7, control knob 12 controls the activation of burner 60 within emitter assembly 40. When control knob 12 is pressed and turned, control valve 78 opens, and gas flows through first fitting 84 and burner flex line 80 into injector 76, which in turn injects the gas into burner 60. Gas enters control valve 78 through second fitting 86, which connects to a propane tank or other energy source through a conventional hose and regulator (not shown). When ignitor 14 is depressed, an electronic signal is sent through a wire to ignitor electrode 74 on burner plate 46 so that a spark ignites gas coming through injector 76 to burner 60. When burner 60 ignites, thermocouple 72 sends a signal through thermocouple wire 82 to control valve 78, which activates control valve 78 to stay open. Conversely, if burner 60 goes out, thermocouple 72 senses that condition and sends a signal to control valve 78 activating it to close. When burner 60 is lit, emitter screens 44 absorb heat radiated from burner 60, causing screens 44 to glow red and radiate heat outward through grate 56. As shown in FIGS. 6 and 7, emitter screens 44 are covered by emitter cap 42.

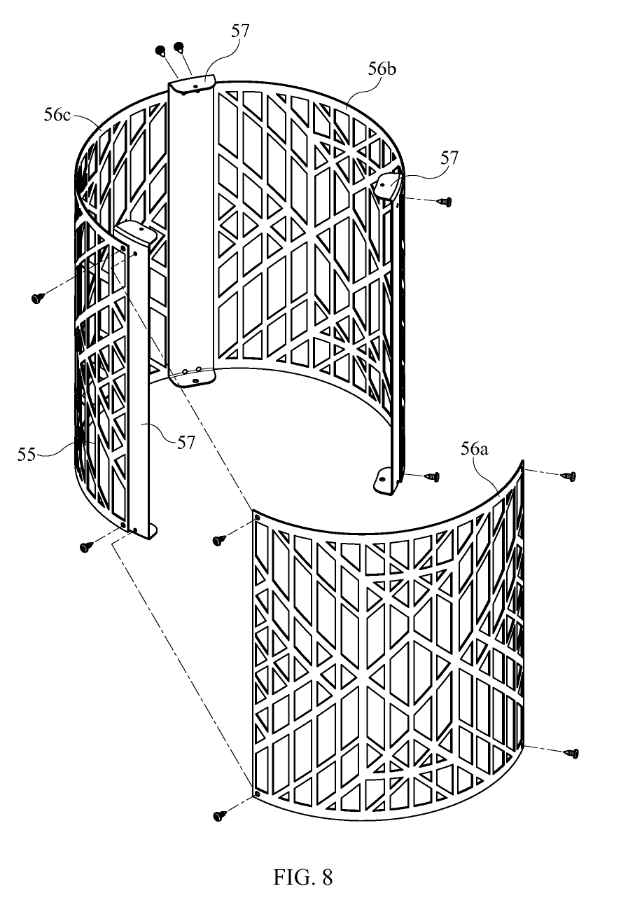

Grate 56 may comprise more than one piece. For example, in the embodiment shown in FIG. 8, grate 56 is formed from three semi-circular segments 56a, 56b, and 56c that are attached to grate pillars 57 and joined together. Grate pillars 57 maintain the shape of grate 56, which circumscribes heating area or combustion chamber 50.

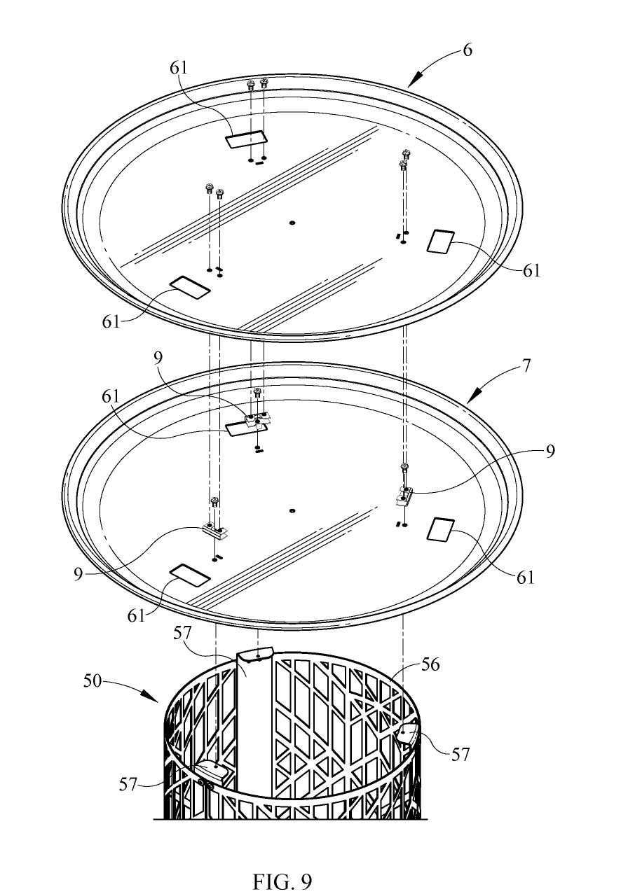

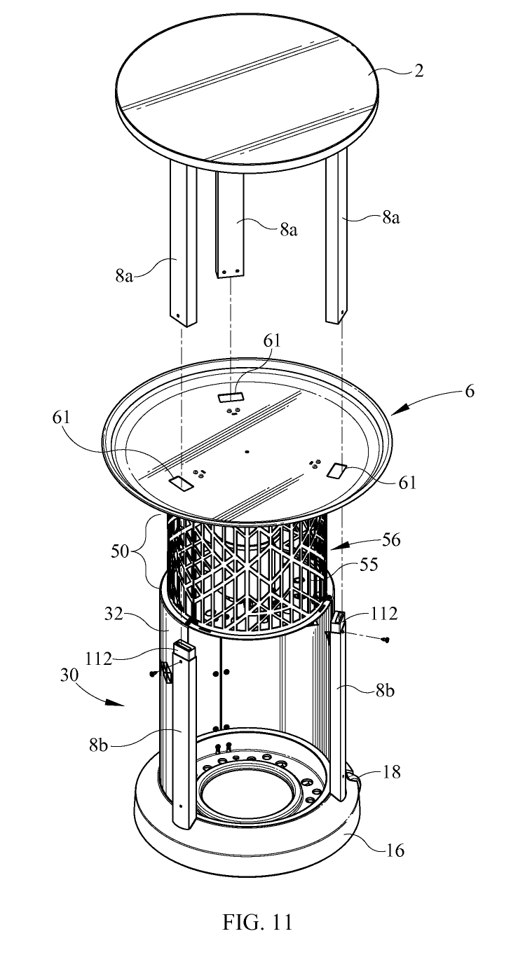

FIG. 9 shows one embodiment of the deflectors 6, 7 in more detail, illustrating them in the shape of a pan. In this embodiment, a top deflector pan 6 is located above a bottom deflector pan 7, and deflector brackets 9 separate the two pans 6, 7 from each other. Deflector brackets 9 also have holes in them through which the pans 6, 7 can be attached to each other, for example by screws, and in turn can be attached, also for example by screws, to grate pillars 57. Deflector pans 6, 7 also have deflector openings 61 through which the upper portions of support pillars 8a can be inserted as shown in FIG. 11, for attachment to corresponding lower portions of support pillars 8b. However, many alternative structures may be utilized. The pans are primarily intended to provide sufficient surface area over which heat may dissipate to guard against overheating of table 2. Preferably, the table 2 is made of a heat insulating material to further guard against overheating. Any number of deflector pans may be utilized in a variety of constructs as needed, in order to maintain the temperature of the table top so that it is sufficiently cool for use.

The space between the pans 6, 7 created by deflector brackets 9 allows heat between the pans to dissipate so that the top deflector pan 6 is somewhat cooler than the bottom deflector pan 7. As shown in FIG. 11, the deflector pans 6, 7 are much wider than the circumference of grate 56 and the enclosed heating area or combustion chamber 50 in order to deflect heat away from the large table 2 above them and towards the lower extremities of people standing or sitting around the table heater.

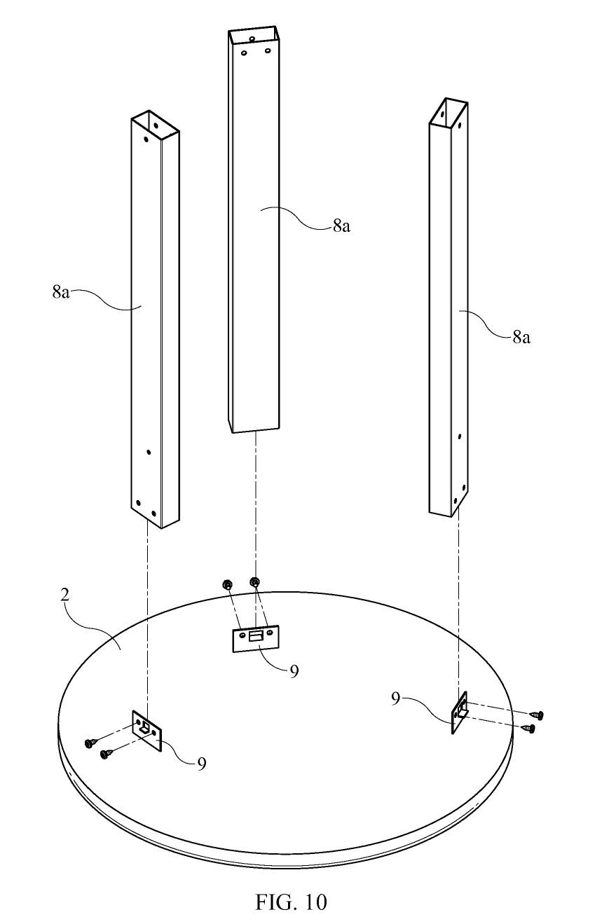

FIG. 10 shows an inverted view of the table 2 before the table 2 is attached to the rest of the table heater 1. The upper portions of support pillars 8 are attached to the table 2 by means of brackets through use of screws or other fasteners and extend vertically down the outside of the heating area or combustion chamber 50 and grate 56 as shown in FIG. 11. After the upper portions of support pillars 8a are attached to the table 2, they can slide through deflector openings 61 and attach to the corresponding lower portions of support pillars 8b as shown in FIG. 1. The upper portions of support pillars 8 may also be attached to grate 56 by appropriate means (not shown) for added support if desired.

As previously referred to with reference to FIGS. 1 and 7, the cabinet assembly 30 has an ignitor 14 and a control knob 12. The ignitor 14 and control knob 12 should be placed where they can respectively communicate with the ignitor electrode 74 and the energy source. It is normally most convenient to place them on the outside of one of the panels 32 of cabinet assembly 30, as shown in FIG. 1, to make them readily accessible to a user.

To light the burner 60, the control knob 12 is preferably designed to be pressed inward and turned to the start position. While the knob 12 is still pressed in, the ignitor 14 is then repeatedly pressed until the burner 60 is lit. After the burner 60 is lit, the control knob 12 is released. To adjust the heat level, the knob 12 can be rotated to adjust the control valve to the desired setting.

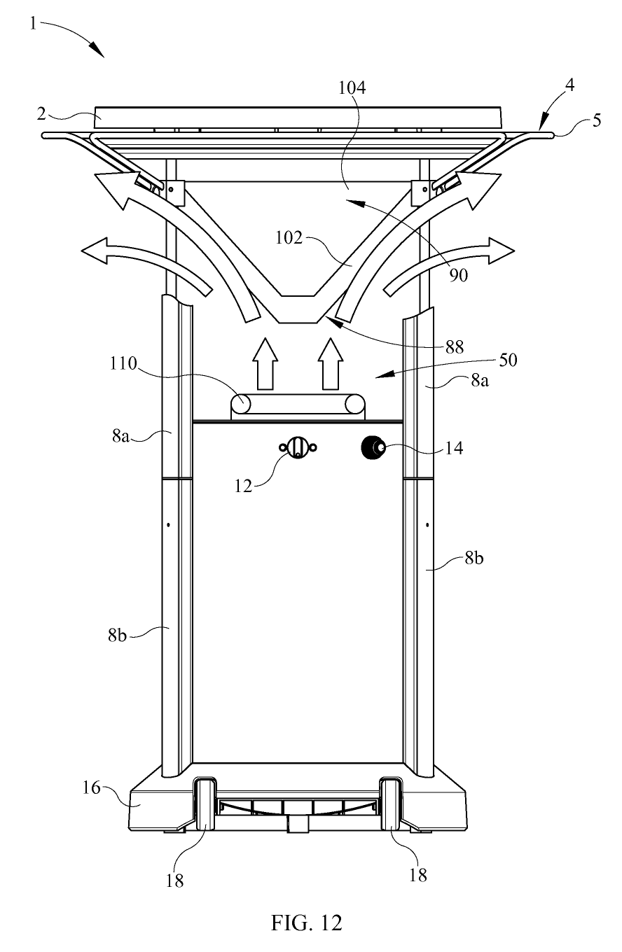

In one embodiment shown in FIG. 12, the deflector cones 102, 104 are not completely conical but are frusto-conical (shown in FIG. 12). In this embodiment, the frusto-conical deflectors 102, 104 have a wide end 90 and a narrow end 88, and the narrow end 88 is oriented toward the heat source so that heat is deflected properly. The conical deflectors 102, 104 allow heat to exit around the heater 1 so that the heater 1 has a 360 degree coverage area. The cone-shaped deflectors 102, 104 are normally used with a ring-type burner 110 as shown in FIG. 12, but they may be used with other heat sources.

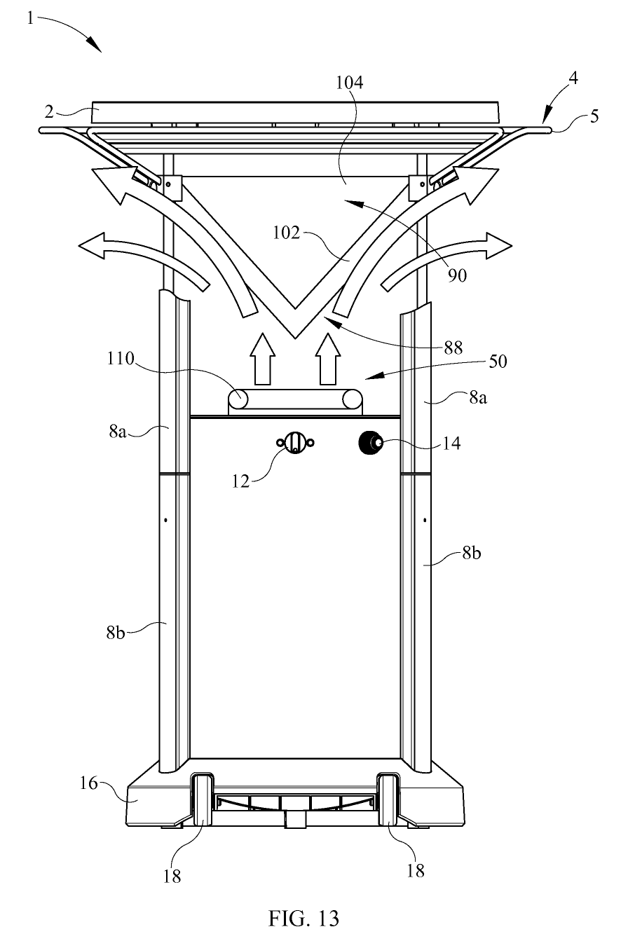

Turning now to FIG. 13, in another embodiment of the invention, the invention comprises a heat source, which may be a ring burner 110, which sits below deflector cones 104, 102 in the heating area or combustion chamber 50. In the embodiment shown in FIG. 12, the second deflector cone 104 is stacked on top of the first deflector cone 102 and placed within it. In this embodiment, first deflector cone 102 is hollow. Both cones serve to deflect heat away from the table 2, as is depicted by the arrows in FIG. 12. The first and second deflector cones 102, 104 can be made of any material that is heat resistant, but they must be substantially cone-shaped in order to deflect heat away from the table top and sideways out of the heating area or combustion chamber 50.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

We claim:

1. A combination table and heater comprising:
a table top;
a heat source positioned below said table top; and
at least one deflector cone situated between said heater and said table top.

2. The combination table and heater of claim 1 further comprising:
a first deflector cone positioned between said table top and said heater; and
a second deflector cone stacked on top of said first deflector cone.

3. The combination table and heater of claim 1, said heater comprising a wire mesh emitter.

4. The combination table and heater of claim 1, said heater comprising a ring burner.

5. The combination table and heater of claim 1, further comprising:
at least one heat guard rail attached to said combination table and heater and positioned away from said table top, said heat guard rail having an outside edge, said outside edge defining an extended area between said table top and said outside edge, wherein said extended area is an open space.

6. A portable combination table and heater comprising:
a heat source;
a table top positioned above said heat source;
at least one deflector cone positioned above said heat source and below said table top;
a cabinet assembly below said heat source and having a cabinet said cabinet being capable of holding an energy source.

7. The portable combination table and heater of claim 6, said heat source comprising a ring burner.

8. The portable combination table and heater of claim 6, said heat source comprising a wire mesh emitter.

9. The portable combination table and heater of claim 6, said energy source comprising a propane tank.

10. The portable combination table and heater of claim 6 further comprising at least one heat guard rail attached to said combination table and heater and positioned away from said table top, said heat guard rail having an outside edge; said outside edge defining an extended area between said table top and said outside edge, wherein said extended area is an open space.

11. A combination table and heater comprising:
a heating area having a heat source;
a table top positioned above said heating area; and
a first deflector cone positioned above said heat source.

12. The combination table and heater of claim 11, said deflector cone comprising a solid object having a wide end and a narrow end, wherein said narrow end is oriented toward said heat source.

13. The combination table and heater of claim 11, said deflector cone comprising a frusto-conical object having a wide end and a narrow end, wherein said narrow end is oriented toward said heat source.

14. The combination table and heater of claim 11 further comprising a second deflector cone positioned between said first deflector cone and said heat source.

15. The combination table and heater of claim 14, wherein said first deflector cone is hollow such that said second deflector cone fits inside said first deflector cone.
